(19) United States
(12) Patent Application Publication
(10) Pub. No.: US 2005/0270376 A1
(43) Pub. Date: Dec. 8, 2005

(54) Image monitoring apparatus

(75) Inventors: Chen-Chang Lin, Taipei City (TW); Chung-Lung Wu, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/114,011

(22) Filed: Apr. 26, 2005

(30) Foreign Application Priority Data
Jun. 4, 2004 (TW) 093208851

(51) Int. Cl. H04N 5/225

(52) U.S. Cl. 348/207.1

(57) ABSTRACT

An image monitoring apparatus for detecting a target image and displaying a monitored image corresponding to the target image on a display device, the image monitoring apparatus includes: an image extraction device for extracting the target image and performing an image encoding process and a format conversion on the target image to output an optical signal; an optical fiber for accepting the optical signal and transmitting the optical signal to a remote end; a server for receiving the optical signal from the optical fiber and performing an image decoding process to obtain the monitored image, and outputting the monitored image to the display device.

### BACKGROUND OF THE INVENTION

1. Field of the Invention

The present invention relates to an image monitoring apparatus and, more particularly, to an image monitoring apparatus utilizing optical fibers as a data transmission medium.

2. Description of the Related Art

As shown in FIG. 1, a prior art image monitoring apparatus comprises an image extraction device 10, a coaxial cable 20, a server 30, and a display device 40. The image extraction device 10 is adopted for extracting a monitored image of a target object and its surrounding, and then outputting encoded image data via the coaxial cable 20 to the server 30. The image extraction device 10 comprises an optical sensor 12, a microprocessor 14, and a network connector 16. The server 30 is used for receiving the encoded image data from the coaxial cable 20 and performing an image decoding process to obtain the monitored image, and then outputting the monitored image to the display device 40. Therefore, a user can watch the display device 40 to monitor the target object and its surrounding.

However, there are some problems when the prior art image monitoring apparatus with the coaxial cable 20 is used in a large-sized building:
1. The prior art image monitoring apparatus has a data transmission distance limitation of 500 m; therefore, a signal amplifier is required to increase the effective data transmission distance.
2. The prior art image monitoring apparatus cannot provide several sets of encoded image data at the same time due to the limited bandwidth.
3. The coaxial cable 20 is heavy and bulky.
4. The prior art image monitoring apparatus has a slow data transmission speed, in the range of megabytes per second, and so the extracted image cannot be displayed on the display device 40 instantaneously.

These problems may cause difficulties for the user when setting up the image monitoring apparatus. Therefore, it is desirable to provide an image monitoring apparatus to mitigate and/or obviate the aforementioned problems.

### SUMMARY OF THE INVENTION

In order to avoid the above-mentioned problem, an image monitoring apparatus of the present invention can be used for detecting a target image and displaying a monitored image corresponding to the target image on a display device, the image monitoring apparatus comprises: an image extraction device for extracting the target image and performing an image encoding process and a format conversion on the target image to output an optical signal; an optical fiber for accepting the optical signal and transmitting the optical signal to a remote end; a server for receiving the optical signal from the optical fiber and performing an image decoding process to obtain the monitored image, and outputting the monitored image to the display device.

The image extraction device comprises an optical sensor, a microprocessor, and an electro-optical signal converter; the server comprises an optical signal detector, a CPU, and a display card; and the optical sensor may be a charge coupled device (CCD) or complementary metal-oxide semiconductor (CMOS).

Other objects, advantages, and novel features of the invention will become more apparent from the following detailed description when taken in conjunction with the accompanying drawings.

### BRIEF DESCRIPTION OF THE DRAWINGS

FIG. 1 is a functional block drawing of a prior art image monitoring apparatus; and

FIG. 2 is a functional block drawing of an image monitoring apparatus according to the present invention.

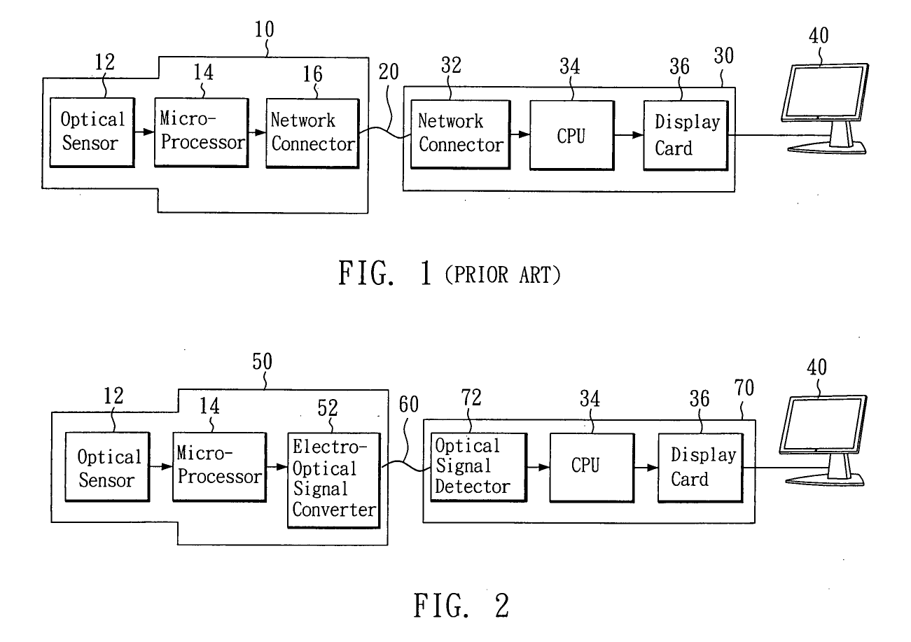

### DETAILED DESCRIPTION OF THE PREFERRED EMBODIMENT

In an embodiment of the present invention, an optical fiber is used as the data transmission medium to replace coaxial cable of prior art devices. The image monitoring apparatus of the present invention comprises an image extraction device 50, an optical fiber 60 and a server 70.

The image extraction device 50 is used for extracting the target object and its surrounding to form a monitored image and performing an image encoding process on the monitored image to output encoded image data to the server 70 via the optical fiber 60. The image extraction device 50 comprises an optical sensor 12, a microprocessor 14, and an electro-optical signal converter 52. The optical sensor 12 is a preferable charge coupled device (CCD), which can sense the target object and its surrounding, and output image extraction data to the microprocessor 14. The microprocessor 14 performs an image encoding process on the image extraction data to output encoded image data to an electro-optical signal converter 52. The electro-optical signal converter converts the encoded image data in the format of electrical signals into an optical signal in the format of light, and then transmits the optical signal to the server 70 via the optical fiber 60.

The optical fiber 60 is used for transmitting the optical signal from the image extraction device 50 to the server 70, which has the following advantages:
1. Convenience—Light weight and small sized, so that it is easy to set up.
2. Versatility—Higher bandwidth for data transmission, which is capable of providing a transmission rate for several sets of optical signals, such as 16 sets of optical signals.
3. Technical effectiveness—Lower power consumption and a longer data transmission distance (which can reach up to 30 km).
4. Technical advance—Anti-interference and not easy to wiretap.
5. Performance—Faster data transmission speeds, such as Gigabytes per second for instant data transmissions.

According to the above-mentioned description, the optical fiber 60 is a better data transmission medium than the coaxial cable 20.

The server 70 is used for receiving the optical signal from the image extraction device 50 and outputting a monitored image to the display device 40. The server 70 comprises an optical signal detector 72, the CPU 34, and the display card 36. The optical signal detector 72 detects the optical signal and then outputs the encoded image data to the CPU 34. The CPU 34 performs the image decoding process on the encoded image data and outputs the monitored image to the display card 36. The display card 36 receives the monitored image and outputs the decoded image data to the display device 40. The display device 40 obtains and the displays the monitored image.

Furthermore, since the optical fiber 60 has a larger bandwidth than the prior art co-axial cable, it allows a plurality of image extraction devices 50 to transmit a number of optical signals, and a time sharing multiplexing process or a frequency sharing multiplexing process can be used as a data transmission method to fully utilize the bandwidth. When the optical signal detector 72 detects more than one set of optical signals, such as 16 sets of optical signals, the CPU 34 separately performs the image decoding process and an image down-scaling process on these sets of optical signals. Therefore, the display device 40 can display all or some of the monitored images, so that the user can monitor more than one object or location at the same time. Therefore, the image monitoring apparatus of the present invention not only can be easy to set up, but also provides instantaneous monitored images and high security.

Although the present invention has been explained in relation to its preferred embodiment, it is to be understood that many other possible modifications and variations can be made without departing from the spirit and scope of the invention as hereinafter claimed.

1. An image monitoring apparatus for extracting a target image and displaying a monitored image corresponding to the target image on a display device, the image monitoring apparatus comprising:
an image extraction device for extracting the target image and performing an image encoding process and a format conversion on the target image to output an optical signal;
an optical fiber for accepting the optical signal and transmitting the optical signal to a remote end; and
a server for receiving the optical signal from the optical fiber and performing an image decoding process to obtain the monitored image, and outputting the monitored image to the display device.

2. The image monitoring apparatus as claimed in claim 1, wherein the image extraction device comprises an optical sensor, a microprocessor, and an electro-optical signal converter.

3. The image monitoring apparatus as claimed in claim 1, wherein the server further comprises an optical signal detector, a CPU, and a display card.

4. The image motoring apparatus as claimed in claim 2, wherein the optical sensor is a Charge Coupled Device (CCD).
